(19) United States
(12) Patent Application Publication
(10) Pub. No.: US 2015/0313203 A1
(43) Pub. Date: Nov. 5, 2015

(54) DEVICE FOR DETERRING WILDLIFE

(71) Applicant: Peter M. DUMOND, Rockyview (CA)

(72) Inventor: Peter M. DUMOND, Rockyview (CA)

(21) Appl. No.: 14/268,659

(22) Filed: May 2, 2014

(51) Int. Cl. A01M 29/06

(52) U.S. Cl. CPC A01M 29/06

(57) ABSTRACT

Disclosed are devices for deterring wildlife, comprising at least one anchor pipe; a center plate connected on one side to a top rod, where in the center plate pivots along the axis of the rod; and at least one rod having a plurality of streamers.

### FIELD OF THE INVENTION

The present invention is in the field of wildlife deterrence devices.

### BACKGROUND OF THE DISCLOSURE

When wildlife enters an area that it is not supposed to, it causes conflict between the human and the animal. Solving wildlife conflicts involves either trapping the animal using animal traps, excluding the animal from accessing the area, for example by using a fence, or injuring the animal. Commonly used methods of preventing wildlife from entering an area involves harming or scaring the wildlife in some way. Thus, there exists a need for a humane way of deterring wildlife from entering an area.

The present disclosure also relates to deterring wildlife from entering an area that might harm the wildlife. It could be positioned in a manner around a tailings pond, lake, fields, gardens, wineries, fruit fields, pastures and many like applications.

### SUMMARY OF THE INVENTION

Disclosed are devices for deterring wildlife, comprising at least one anchor pipe; a center plate connected on one side to a top rod, where in the center plate pivots along the axis of the rod; and at least one rod having a plurality of streamers.

### BRIEF DESCRIPTION OF THE DRAWINGS

FIG. 1 illustrates one embodiment of the device disclosed herein.

FIG. 2 depicts one embodiment of the center plate of the device disclosed herein.

FIG. 3 illustrates the movement of an embodiment of the center plate in the breeze.

FIG. 4A shows a front view of the embodiment of a streamer assembly disclosed herein.

FIG. 4B shows a side view of the embodiment of a streamer assembly disclosed herein.

### DETAILED DESCRIPTION OF THE EMBODIMENTS

The present disclosure relates to devices that deter wildlife from entering an area that might harm, or be harmed by, the wildlife. The devices mimic the features of large birds of prey, or other animals, which frighten the wildlife. A feature of the presently disclosed devices is that they rotate, make noise, and flutter with wind, unlike the traditional scarecrow.

The devices disclosed herein can be positioned around a tailings pond, lake, fields, gardens, wineries, fruit fields, pastures and the like.

Embodiments of the device are further described with reference to the accompanying drawings.

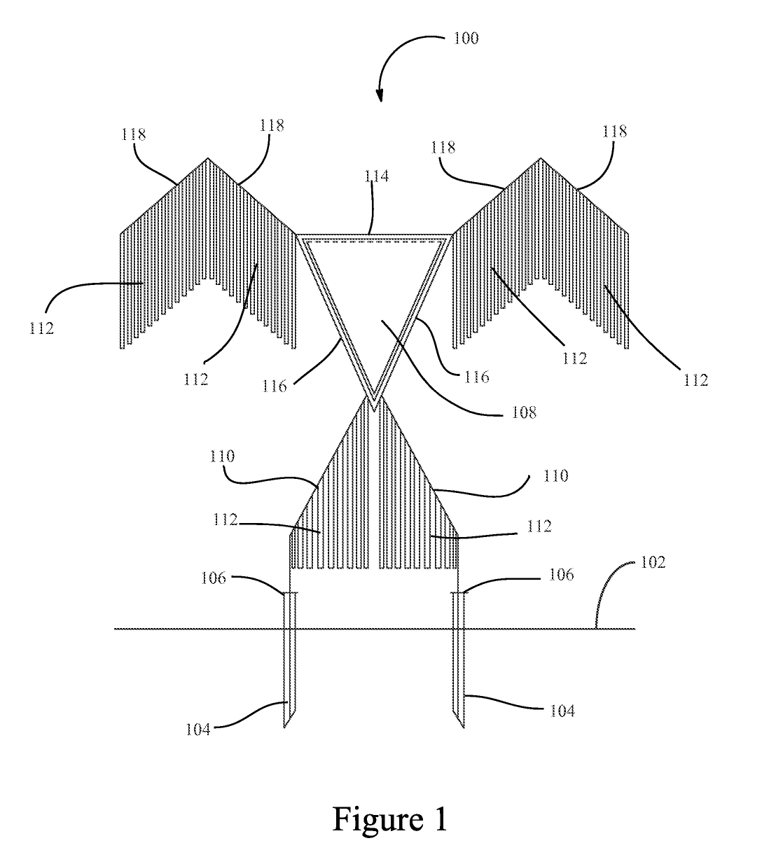

Referring to FIG. 1, an embodiment of the presently disclosed devices is illustrated. The device 100 of FIG. 1 is in the shape of a bird of prey. In other embodiments, the device 100 has the shape of other animals, such as a lion, bear, tiger, and the like. Thus, the concept of the present devices is not to be limited by the type of animal that is represented.

The device 100 is anchored to the ground 102 by a plurality of pipes 104 that are driven into the ground 102. In some embodiments, for example the one shown in FIG. 1, the distal ends of the pipes 104 is slanted to provide for easier penetration into the ground.

In some embodiments, the pipe 104 comprises a flat surface 106 positioned at some distance from the distal tip of the pipe 104. In certain embodiments, the flat surface 106 is a washer that is affixed to the pipe 104. In other embodiments, the flat surface 106 is a metal or polymer surface. The flat surface 106 serves several functions. For example, the flat surface 106 provides for a foothold for the user to press down on the pipe 104 to drive it into the ground 102. The flat surface 106 also provides an indicator for the user to know the how deep the pipe 104 has been driven to the ground 102. In these embodiments, once the flat surface 106 reaches the ground 102, the user stops pressing down more.

The length and the diameter of pipe 104 can be of any measurement that provides stability to the device 100. Thus, the size of the device 100 generally determines the size of the pipe 104. In some embodiments, the pipe 104 has a diameter of 1 inch. In other embodiments, the diameter is 0.75″, 1.25″, 1.5″, 2″ or greater than 2″. Smaller diameter pipes can also be used. In some embodiments, the pipe 104 is 1 foot long, while in other embodiments, the length of the pipe 104 is 6″, 8″ 10″, 1.25′, 1.5′, 2′, or greater than 2′.

In some embodiments, the device 100 comprises a base, not shown in the drawings. In some of these embodiments, the pipes 104 are welded, or otherwise attached to the base. In other embodiments, the base comprises a plurality of pipes, into which the pipes 104 are inserted. The base provides stability for the device 100 and renders the device more mobile and easier to use. In some embodiments, the base is rectangular or square. In other embodiments, the base is a circle. In still other embodiments, the base has other regular or irregular geometric shape.

In the embodiments where a base is used, the base has a large enough surface area to prevent the device 100 from falling over in the wind. The surface area of the base is generally dictated by the size of the device 100. In some embodiments, the base has a side that is between 1 foot and 10 feet long. In other embodiments, the base has a side that is between 3′ and 8′ long. For example, the base is 4′×6′ or 4′×8′.

A pivoting center plate 108 is connected to the pipes 104 by connecting bars 110. In some embodiments, the connecting bars 110 has a diameter of 0.75 inch. In other embodiments, the diameter is 0.25″, 0.5″, 1″, 1.25″, 1.5″, 2″ or greater than 2″.

In some embodiments, streamers 112 are attached to the connecting bars 110, as described further below. The streamers 112 flutter in the breeze and provide the appearance of movement, which helps to further frighten and deter the wildlife.

While the embodiment of FIG. 1 shows the center plate 108 to be a triangle, it is understood that the center plate 108 can be of any shape, for example, a circle, a square, a trapezoid, or an irregular shape.

The center plate 108 is connected to a top bar 114 and is surround by the side bars 116. In some embodiments, the center plate 108 is not connected to the side bars 116. Instead, the side bars 116 provide the connectivity means for the top bar 114 to be connected to the rest of the device. As described more fully below, the center plate 108 pivots along the axis of the top bar 114, such that the bottom point of the center plate 108 can move above and below the plane defined by the top bar 114 and the side bars 116. In some embodiments, the face of a vicious animal, such as a bird of prey, a lion, or a bear, is drawn on the center plate 108. The center plate 108 rotates along the axis of the top bar 114 in the breeze, which provides the appearance of movement, and helps to further frighten and deter the wildlife.

In some embodiments, the top bar 114 has a diameter of 0.75 inch. In other embodiments, the diameter is 0.25″, ⅜″, 0.5″, 1″, 1.25″, 1.5″, 2″ or greater than 2″.

In some embodiments, to the top bar 114 are connected a plurality of additional wing bars 118. In the embodiment shown in FIG. 1, two wing bars 118 are attached to either side of the top bar 114, and another wing bar 118 is attached to the distal end of each of the wing bars 118 that is connected to the top bar 114. Thus, the embodiment of FIG. 1 shows four additional wing bars. Other arrangements are contemplated herein. For example, additional wing bars 114 can be attached to the distal ends of the illustrated wing bars 114, or only two wing bars 114 can be used. In other embodiments, the wing bars 114 come out at an angle, instead of being in the same plane as the center plate 108.

In some embodiments, the wing bar 118 has a diameter of 0.75 inch. In other embodiments, the diameter is 0.25″, 0.5″, 1″, 1.25″, 1.5″, 2″ or greater than 2″.

The various pipes and the bars disclosed herein can be connected to each other using a variety of means known in the art. For example, they can be welded together to create the desired shape. In other embodiments, a connector is used and the end of each bar is inserted into the connector to create a friction lock mechanism. In other embodiments, the end of one bar comprises a spring pin while the end of another bar has a hole that fits the head of the pin. Any connecting mechanism that allows for an easy and quick assembly of the device is contemplated.

In some embodiments, the pipes 104, the connecting bars 110, the top bar 114, the side bars 116, and the wing bars 118 is each independently a stainless steel pipe. In other embodiments, the pipes 104, the connecting bars 110, the top bar 114, the side bars 116, and the wing bars 118 is each independently made up of wood, anodized aluminum, anodized titanium, anodized magnesium, anodized zinc, brass, or a polymer, such as polyvinyl chloride (PVC). It is preferable that these pipes and bars be made up of a material that is resistant to oxidation or is not easily degradable in the environment.

In some embodiments, the pipes 104, the connecting bars 110, the top bar 114, the side bars 116, and the wing bars 118 is each independently a hollow pipe, while in other embodiments, it is a filled rod.

The size of the device 100 can vary according to the desired use. In some embodiments, each of the pipes 104, the connecting bars 110, the top bar 114, the side bars 116, and the wing bars 118 is independently between 6 inches and 10 feet long. In other embodiments, each of the pipes 104, the connecting bars 110, the top bar 114, the side bars 116, and the wing bars 118 is independently between 1′ and 8′ long.

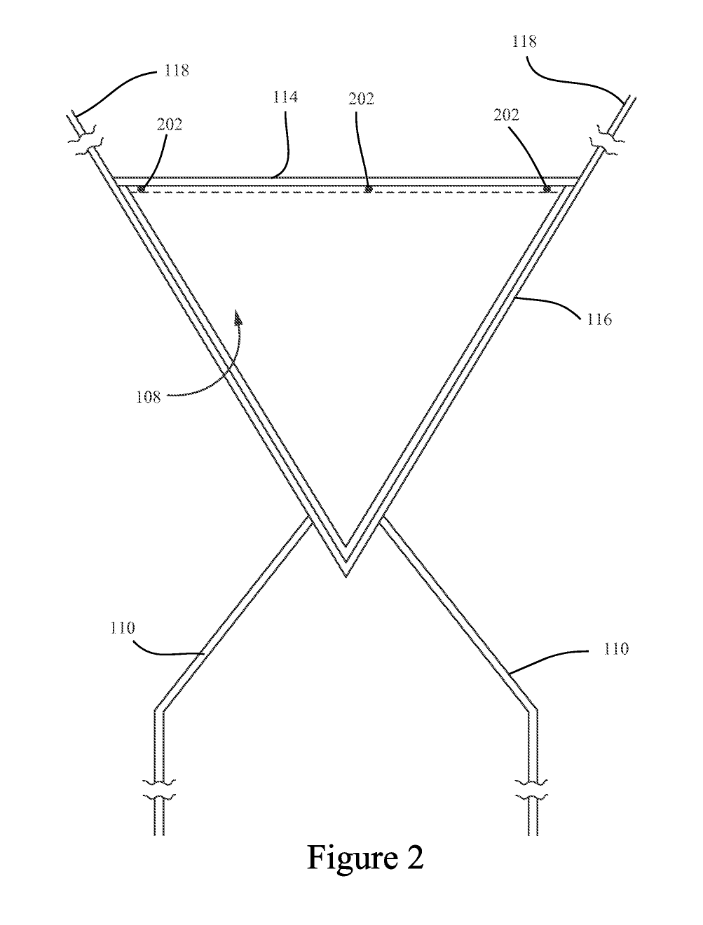

FIG. 2 shows a close up view of the center plate 108. In the illustrated embodiment, the plate 108 is connected to the top bar 114 by bolts 202. In other embodiments, the center plate 108 comprises a sleeve at the top, through which the top bar 114 is threaded. Thus, in some embodiments, the top bar 114 can rotate along its long axis when pressure, for example wind pressure, is exerted on the plate 108. In other embodiments, the top bar 114 does not rotate and only the center plate 108 rotates with pressure.

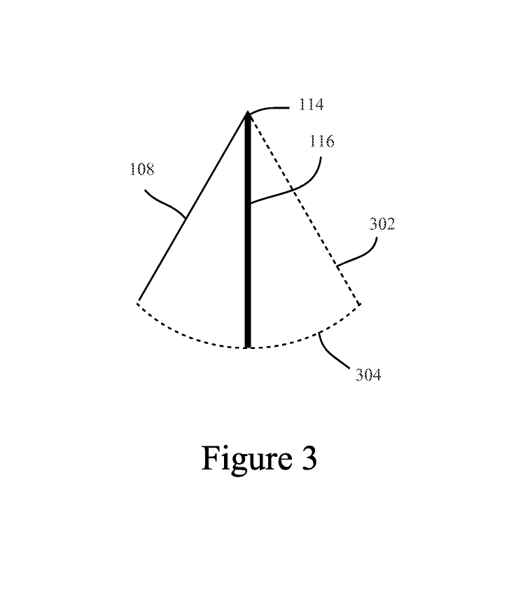

FIG. 3 shows a side view of the plate 108, showing the range of motion of the illustrated embodiment. When wind blows, the plate 108 swings to the left, to the position shown as “108” in FIG. 3, and then through the plane defined by the side bars 116, and back to the right, to position 302, along the arc 304.

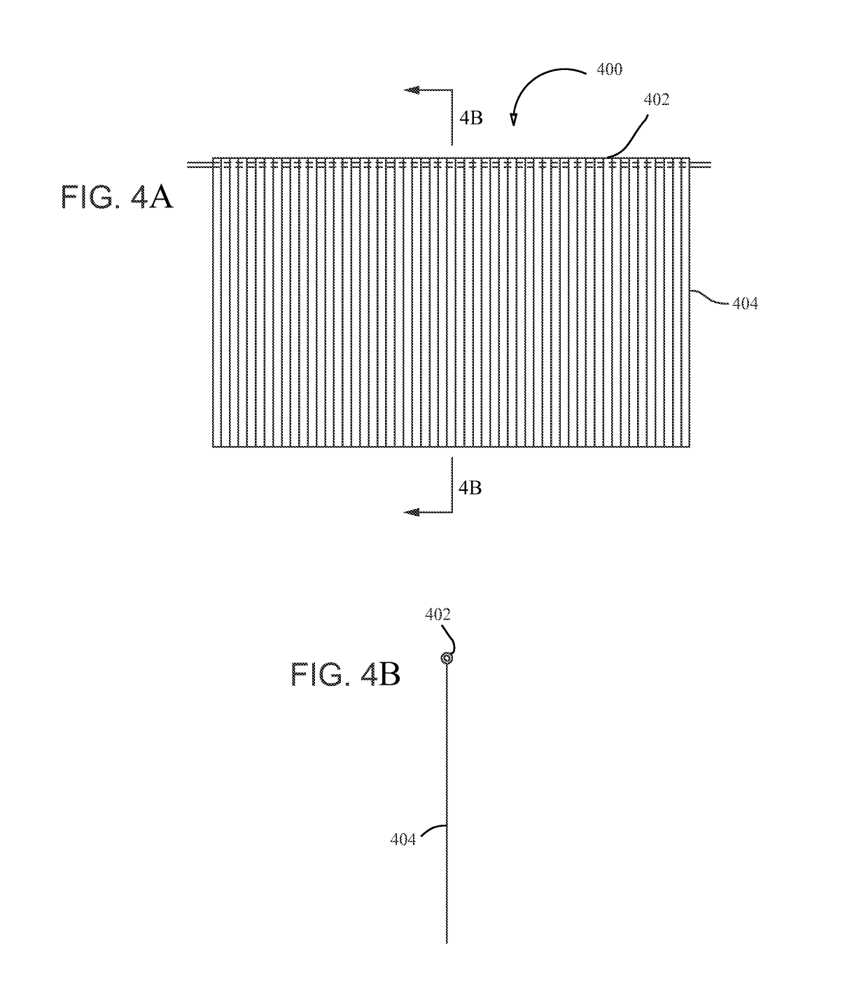

FIG. 4 shows an embodiment of the streamer assembly 400 used with the devices disclosed herein. FIG. 4A shows a front view of the assembly 400. The streamer assembly 400 comprises a rod 402 and a plurality of streamers or ribbons 404 attached thereto. In some embodiments, the only point of connectivity of an individual streamer 404 to another body is the connectivity of the streamer 404 to the rod 402. Thus, the streamers 404 can flutter and move in the breeze. FIG. 4B shows the cut out view of the assembly 400 along the A-A line.

The streamer assembly 400 is used throughout the device as described above. For example, in some embodiments, the combination of rod 110/streamer 112 or the combination of rod 118/streamer 112, described above, are the streamer assembly 400.

In some embodiments, the streamers are brightly colored to attract the attention of the wildlife. In certain embodiments, the colors are chosen to represent dangerous threats to the wildlife and thereby frighten and deter them. In other embodiments, the colors are chosen for their aesthetic quality.

In some embodiments, the streamers are made up of plastic. In other embodiments, the streamers are made up of metal, for example, a non-oxidizable metal such as stainless steel. In these embodiments, when the streamers flutter there is an accompanying noise that further frightens and deters wildlife.

While the present disclosure has been described and illustrated herein, it is intended that the specification and examples be considered as exemplary only, with the true scope and spirit of the invention being indicated by the following claims.

What is claimed is:

1. A device for deterring wildlife, comprising:
at least one anchor pipe;
a center plate connected on one side to a top rod, where in the center plate pivots along the axis of the rod; and
at least one rod having a plurality of streamers.

2. The device of claim 1, comprising two anchor pipes.

3. The device of claim 1, wherein the anchor pipe comprises a flat plate.

4. The device of claim 1, comprising four rods having a plurality of streamers.

5. The device of claim 1, wherein the center plate has a shape selected from the group consisting of a triangle, a circle, a square, a trapezoid, and an irregular shape.

6. The device of claim 1, wherein the face of a predator is depicted on the center plate.

7. The device of claim 1, wherein the streamers flutter in the breeze.

8. The device of claim 1, wherein the center plate pivots around the top rod in the breeze.
